(19) United States
(12) Patent Application Publication
(10) Pub. No.: US 2023/0058383 A1
(43) Pub. Date: Feb. 23, 2023

(54) NETWORK AND METHOD OF COLLECTING AND PROCESSING PACKET INFORMATION

(71) Applicant: HIRSCHMANN AUTOMATION AND CONTROL GMBH, Neckartenzlingen (DE)

(72) Inventor: Florian MUECK, Leonberg (DE)

(21) Appl. No.: 17/784,633

(22) PCT Filed: Oct. 7, 2020
(86) PCT No.: PCT/EP2020/078077

§ 371 Date: Nov. 8, 2022

(30) Foreign Application Priority Data
Feb. 17, 2020 (DE) 10 2020 104 098.9

(51) Int. Cl. H04L 43/106; H04L 43/028

(52) U.S. Cl. CPC H04L 43/106; H04L 43/028

(57) ABSTRACT

The invention relates to a network device (10) comprising at least two ports for connecting network subscribers, and comprising at least one memory (12) for storing data, with each port containing a transmitting unit (2) and a receiving unit (1). According to the invention, each receiving unit (1) and each transmitting unit (2) also comprises a time stamp unit (4) and the time stamps of incoming data packets of the receiving units (1) and outgoing data packets of the transmitting units (2) generated by the time stamp units (4) can be stored in the memory (12). The invention also relates to a method for collecting and processing packet information in said network device, in which the time stamp units (4) generate time stamps of the incoming and outgoing data packets and store them in the memory (12). The time stamp data aggregated in this way can be forwarded to the ports using packet generation (13) and packet delivery (14).

The invention relates to a network device and to a method of detecting and processing packet information with a network device. This invention is intended to enable visualization of the chronological sequence of incoming and outgoing data packets in a network device with the aid of hardware extensions within this device according to the features of the preamble of claim 1.

Corresponding hardware devices are required in computer networks in order to be able to send and distribute data from one terminal to another. For this purpose, the data are subdivided into data packets. For this purpose, TCP/I P networks are known.

It is known that network devices represent simple nodes (network nodes) in order to generate a star point for terminals. These devices are referred to as network hub.

Furthermore, network devices are known that include a programmable controller in order to distribute the data packets in a targeted manner in a network. These devices are referred to as network switches.

It is also known, for example, from DE 60 2006 000 171 [US 2006/0153201] to assign different priorities to different data packets in order to efficiently control the data traffic at the network node.

The concept of time stamps of packets is found in existing prior art applications, IEEE 1588 uses it for the purpose of time synchronization, only certain packets being time-stamped here. Ethernet test devices also exist that create highly accurate time stamps, but are not integrated into a network node.

Existing methods of the prior art that operate by time stamps of trigger packets, only detect the time behavior relating to the trigger packets. If the inline time stamping is used, these packets are also changed.

However, all known devices and methods for data distribution in a network may not create a detailed image of the entire time behavior at a network node.

The object of invention is therefore to create diagnostic possibilities for “Time Sensitive Networking” (TSN) networks that enable detailed insight into the time behavior of the packets involved. Such a diagnosis can then be used to check the actual implementation of a dispatch schedule of the data packets. Furthermore, a solution integrated in a network device is to be created.

This object is achieved by the features of patent claim 1 and of independent claim 7.

According to the invention, a network device is proposed for this purpose that forms a node in a network. For this purpose, the network device includes at least two ports, each port including a transmitter and a receiver. The subscribers of the network are connected via the ports, so that the network device forms the center of a star network.

Each receiver and each transmitter further includes a time stamper that can assign time stamps to the incoming and outgoing data packets of a port. To record this time stamp, the network device has an internal memory.

Thus, according to the invention a network device with a plurality of ports supplies a time stamp to or each incoming and outgoing packet in each port. This time stamp can be derived from a precise hardware clock in turn synchronized network-wide, for example, via network-based time synchronization methods as known from IEEE 1588.

These time stamps are aggregated in the central memory within the network device for further processing.

In this configuration of a network device, the time stamp can then be followed at any time the individual data packets have been accepted and/or sent to the network device. This makes it possible to determine the transmission times between two network devices.

In a further development of the invention, the query of the time stamp is managed by the ports before storage in the central memory via a central entity, a so-called arbiter. This thus manages the available bandwidth for the time stamp data of the ports.

As an alternative to a central arbiter, the ports may thus include their time stamp data into a daisy chain topology for such data.

With such an arbiter, it is possible to receive the time stamp of the ports and to transmit them to the central memory. The presence of the time stamps thus collected allows checking whether data packets of the network devices are sent or received within the shift schedule.

The arbiter can thus filter the time stamps of the ports and deposit them in the memory. As a result, an overview of time stamps can be generated in the memory from can determine whether packets have been delivered in good time.

If the time stamp available in the memory shows that the shim of a data packet lasts too long, an early transmission can be initiated. For this purpose, transmission times to the individual network subscribers can be calculated in advance by the time stamp.

The arbiter does not have to collect all the time stamps in the memory, but can deposit time stamps into the memory according to specified rules. If, for example, time stamps already present can already calculate the transmission times to a network subscriber, further time stamps can be filtered out, which means that they are not stored in the memory. However, the arbiter can also collect old time stamps in the memory.

The data packets, which can be generated by a packet generator from the time stamp collected in the memory, can also be transferred to the ports according to the advanced determination of the shifting times.

In a further development of the invention, the time stamps can be encoded with further data packet-related information in order to show more detailed data about the network traffic. The time stamp encoded with further data are referred to below as metadata It is proposed, in a particular embodiment, to assign an event generator to each receiving and each transmitter, which event generator processes the time stamps with the further information relating to metadata for enrichment, for example the following information (no-order list):
Length of the data packet
Traffic class (“traffic”)
Source and destination MAC address
Ether type
VLAN ID
e VLAN tag
FCS checksum OK or not
Address (n) in switch tables is known or not
Extract the frame content at a selectable position IEEE 802.1CB/Qci stream_handle
Sequence number of redundancy protocol (HSR/PRP/.1CB)
Frame Preemption information
   Classification Preemptable/Express
   frame number
Fragment number
Start/end of a fragmented data packet
Errors in reconstruction.

Whether and which metadata are used for enrichment may be configured by the user to tailor the resulting amount of data to needs.

In a further development of the invention, metadata for data reduction can be mapped to fewer useful data bits by means of hash methods while accepting hash collisions, since a large quantity of metadata can arise in the switch at a high traffic load.

In a further development of the invention, pre-filtering can be carried out already during acquisition of metadata by the event generators, in accordance with one or more data fields that have been enriched by the metadata in order to detect only such metadata as are of interest. Here, entire ports in the transmitting and/or receiving direction can also be excluded from the metadata generation. This also lowers the resulting load.

In a further development of the invention, in case of a high simultaneous number of occurring metadata, a loss of metadata arising from overloading of the interface of the central memory can be detected by the event generators and/or the arbiter. This loss is stored and encoded into the central memory for the next metadata successfully transferred to the central memory so that information about the temporary loss of information by congestion can be generated. This can take place via the ports or suitable signal devices outputting onto the network device.

In a further development of the invention, in addition to the ports as a source of metadata, further sources can exist. The recording of the following information (in non-final enumeration) appears to be useful:
Exceeding certain time thresholds (such as the second threshold) of the hardware clock
   In this way, the time continuity of the metadata can be maintained even if no data packets arrive for several seconds if the metadata in their time stamps contain only a limited section of the time vector of the hardware clock.
Status information about the switch, such as utilization of queues, buffers
Problems occurring in the switch such as overload or internally detected errors
Externally influenced events, such as the build-up or degradation of a left of one of the ports, or a change in speed

In a further development of the invention, the metadata are further processed based on the content of the central memory to Ethernet packets. The address and control data of these packets can be programmed by the user. If certain criteria are present (fill level of the central memory, expiration of a time interval), the Ethernet packets are transferred to ports of the switch, which are selectable by the user or predefined by the switch tables, for packet transmission. In this case, the normal dispatch mechanisms are used in order not to disturb the real-time behavior of a TSN scheduler.

An instance (e.g. software) in the network of the switch may receive, filter, aggregate and display received metadata packets from one or more network devices running the method.

Through the direct generation of Ethernet packets in the network device, latency- and bandwidth-limited quantum-of-band mechanisms, such as, for example, the register set of the network device, which can be connected to an already highly loaded CPU via a bus with a low bandwidth, are avoided.

As an alternative or in addition to the direct generation of the packets in the network device, the central memory can be read out via out-of-band mechanisms, such as, for example, the register set of the network device.

Further features of the network device according to the invention and the method are described below and explained with reference to the figures where:

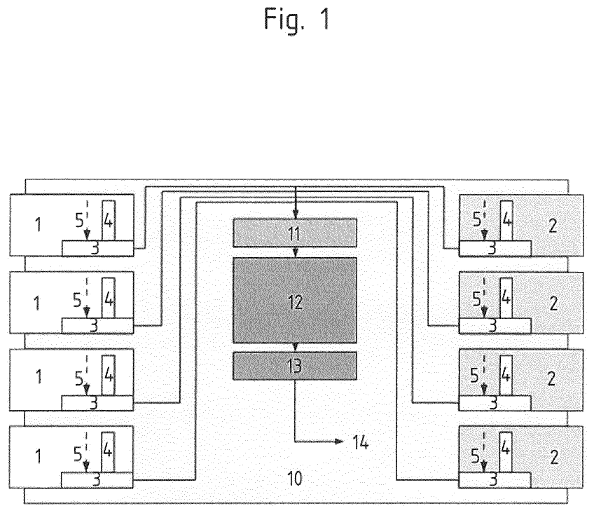

FIG. 1 is an overview of a network device according to the invention with event generators as transmitters (TX) and receivers (RX),

FIG. 1 shows a network device 10 according to the invention with four ports, these ports each being subdivided into a respective transmitter 2 and a receiver 1. The terminals of the network are connected to these ports and the network device can receive data packets (at the receivers 1) and transmit them (at the transmitters 2).

The network device includes a memory 12 that can store digital data and hold them for retrieval. The transmitters 2 and receivers 1 are also each equipped with a respective time stamper 4 suitable for supplying time stamps to the incoming and outgoing data packets and storing them in the memory 12.

Furthermore, the transmitters 2 and receivers 1 are equipped with event generators 3 that assign metadata to the individual time stamps, such as incoming and/or outgoing data packets.

The time stamps enriched as metadata are provided to an arbiter 11. After arbitration, the metadata are stored in the central memory. When dispatch conditions are met, the transmission is done as an Ethernet packet via the transmitters 2. This can be done, for example, via a packet generator 13 that supplies the generated packets to the packet dispatch 14 and thus to the individual ports or transmitters 2. The packet is switched at the transmitters 2 that are configured by the user or as determined via tables in the network device.

Dispatch conditions for triggering the sending of a packet with time stamp data are configurable and may be (no order list):
Fill level of memory 12 in excess of a configured threshold
Reaching a predetermined point in time
Detection of a packet for an urgent event

The present invention is not limited to the foregoing features. Rather, further embodiments are possible. Thus, an instance in the network could be provided that collects and further aggregates the information aggregated in packets from different network nodes.

The novelty is the integration into a network device that has previously used time stamps only for the purpose of time synchronization. The time behavior of the entire or filtered traffic in a productive environment without topology change or interruption of data streams can only be measured by this integration.

The classical approach of the distributing all the entire data traffic to several ports leads to large amounts of data and requires an interruption of the link when external “taps” are used. Both are avoided with the proposed method.

Generating data packets for sending the metadata by an event generator ensures that the CPU associated with the network device is not being loaded with this task. Metadata from a plurality of network devices supporting the method in a network can be detected by the use of MAC addresses of one or more measurement stations processing the data packets by switching in the network.

### LIST OF REFERENCE SYMBOLS

1 Receiver
2 Transmitter
3 Event generator
4 Time stamper
5 Metadata
10 Network device
11 Arbiter
12 Memory
13 Packet generator
14 Packet dispatch

1. A network device comprising:
a memory for storing data and
at least two ports for connecting network subscribers and each including a transmitter and a receiver each in turn including a respective time stamper for storing time stamps of incoming data packets of the receivers and/or outgoing data packets of the transmitters in the memory.

2. The network device according to claim 1, wherein each transmitter and each receiver has an event generator for generating metadata including the time stamps.

3. The network device according to claim 1, further comprising:
at least one arbiter for filtering incoming time stamps and/or incoming time stamps to the memory.

4. The network device according to claim 1, further comprising:
at least one packet generator for sending data packets through the transmitters.

5. The network device according to claim 1, further comprising:
a filter for filtering time stamps or metadata to be stored.

6. The network device according to claim 1, further comprising:
a clock whose time is used for generating the time stamps.

7. A method of detecting and processing packet information in a network device according to claim 1, wherein the time stampers generate time stamps of the incoming and outgoing data packets and store them in the memory.

8. The method according to claim 7, wherein the time stampers generate time stamps of all incoming and outgoing data packets and store them in the memory.

9. The method according to claim 7, further comprising the step of:
effecting packet dispatch at a point in time that is calculated as a function of the time stamp available in the memory.

10. The method according to claim 7, further comprising:
an event generator for generating metadata that contain the time stamps.

11. The method according to claim 10, wherein the metadata contain data-packet-specific data.

12. The method according to claim 10 wherein, instead of the metadata, a code generated by a HASH method is stored in the memory.

13. The method according to claim 7, further comprising:
means for detecting an overload of the memory and generating a corresponding message when an overload.

14. The method according to claim 7, wherein internal events in the network device are likewise provided with time stamps and are stored in the memory.

15. The method according to claim 7, wherein the data of the memory can be forwarded via the packet generator to the packet dispatch for sending to the ports or the network device can send the data of the memory via other suitable interfaces.
